(19) United States
(12) Patent Application Publication
(10) Pub. No.: US 2014/0052848 A1
(43) Pub. Date: Feb. 20, 2014

(54) LATENCY VIRTUALIZATION

(71) Applicants: Matthew Clothier, Somerset (GB); Sean Corbett, London (GB); Edward Elliott, West Sussex (GB); Martin Kirkby, Leeds (GB); Robert A'Court, London (GB); Andrew McNeil, London (GB)

(72) Inventors: Matthew Clothier, Somerset (GB); Sean Corbett, London (GB); Edward Elliott, West Sussex (GB); Martin Kirkby, Leeds (GB); Robert A'Court, London (GB); Andrew McNeil, London (GB)

(73) Assignee: DATA ACCELERATOR LTD., London (GB)

(21) Appl. No.: 13/896,239

(22) Filed: May 16, 2013

Related U.S. Application Data
(60) Provisional application No. 61/684,035, filed on Aug. 16, 2012.

(51) Int. Cl. H04L 12/26

(52) U.S. Cl. CPC H04L 43/045
USPC 709/224

(57) ABSTRACT

A technique involves placing a data acceleration engine between an end user device and a host device. The host device provides data associated with a client application to the data acceleration engine, which provides the data to the end user device. If the data acceleration engine is on the host device, content from a datastore is served to the data acceleration engine as if the data acceleration engine were a client running the client application locally; therefore, latency normally associated with a network between the content datastore and the client device is eliminated. If the data acceleration engine is on the end user device and has received at least some data in advance of a relevant query, responses to the query also do not have latency associated with a network. The data acceleration engine can be implemented as a series of data acceleration engines between end user and host devices.

### CROSS-REFERENCE TO RELATED APPLICATIONS

This application claims the benefit of U.S. Provisional Application Ser. No. 61/684,035 filed Aug. 16, 2012, which is incorporated by reference herein.

### BACKGROUND

Improving performance of applications is an ongoing area of research and development. One aspect of performance is latency, which is introduced, for example, when there is a delay between a query and a response to the query. Nevertheless, it remains desirable in some instances to implement application servers that enable a device to query a datastore associated with a hosted application over a network.

### SUMMARY

A technique for latency virtualization involves placing a data acceleration engine between an end user device and a host device. The host device provides data associated with a client application to the data acceleration engine, which provides the data to the end user device. If the data acceleration engine is on the host device, content from a content datastore is served to the data acceleration engine as if the data acceleration engine were a client running the client application; because the data acceleration engine is local, latency normally associated with a network located between the content datastore and the client device is eliminated. If the data acceleration engine is on the end user device and has received at least some data in advance of a relevant query, responses to the relevant query also do not have latency associated with a network. The data acceleration engine can also be implemented as a series of data acceleration engines between the end user device and the host device.

### BRIEF DESCRIPTION OF THE DRAWINGS

FIG. 1 depicts a diagram of an example of a system for latency virtualization.

FIG. 2 depicts a diagram of an example of a system with a client-side data accelerator.

FIG. 3 depicts a diagram of an example of a system with a server-side data accelerator.

FIG. 4 depicts a diagram of an example of a system with a series of data accelerators.

FIGS. 5A and 5B depict a flowchart of an example of a method for latency virtualization.

FIG. 6 depicts a state diagram of an example of states of an application with virtualized latency.

### DETAILED DESCRIPTION

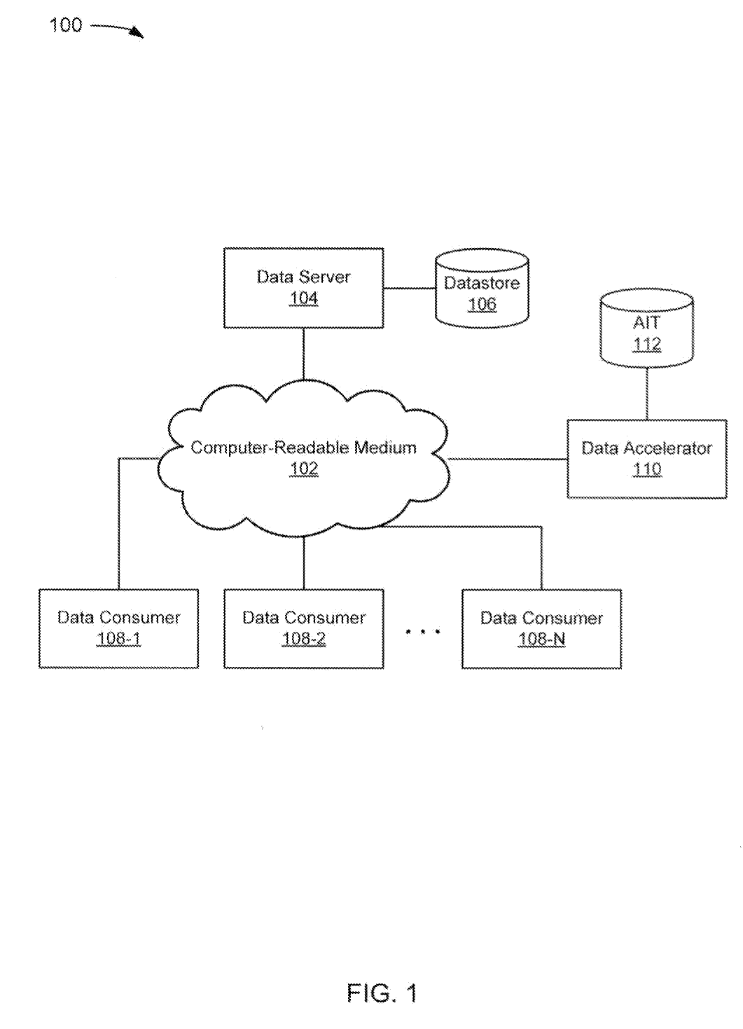

FIG. 1 depicts a diagram 100 of an example of a system for latency virtualization. In the example of FIG. 1, the diagram 100 includes a computer-readable medium 102, a data server 104, a datastore 106, data consumers 108-1 to 108-N (collectively, the data consumers 108), a data accelerator 110, and an application intelligence table (AIT) 112.

In the example of FIG. 1, the computer-readable medium 102 can include a networked system that includes several computer systems coupled together, such as the Internet, or a device for coupling components of a single computer, such as a bus. The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the web and is coupled to the Internet. The physical connections of the Internet and the protocols and communication procedures of the Internet and the web are well known to those of skill in the relevant art. For illustrative purposes, it is assumed the computer-readable medium 102 broadly includes, as understood from relevant context, anything from a minimalist coupling of the components illustrated in the example of FIG. 1, to every component of the Internet and networks coupled to the Internet.

A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor.

The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The term “computer-readable storage medium” is intended to include physical media, such as memory.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor.

The bus can also couple the processor to the interface. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device.

In one example of operation, the computer system can be controlled by operating system software that includes a file management system, such as a disk operating system. File management systems are typically stored in non-volatile storage and cause the processor to execute the various acts required by the operating system to input and output data and to store data in the memory, including storing files on the non-volatile storage. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. Another example of operating system software with associated file management system software is VM (or VM/CMS), which refers to a family of IBM virtual machine operating systems used on IBM mainframes System/370, System/390, zSeries, System z, and compatible systems, including the Hercules emulator for personal computers.

Some portions of this paper may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not necessarily inherently related to any particular computer or other apparatus. Various general purpose systems may be used with programs to configure the general purpose systems in a specific manner in accordance with the teachings herein, or it may prove convenient to construct specialized apparatus to perform the methods of some embodiments. The required structure for a variety of these systems will appear from the description below. In addition, the techniques are not described with reference to any particular programming language, and various embodiments may thus be implemented using a variety of programming languages.

Referring once again to the example of FIG. 1, the data server 104 is coupled to the computer-readable medium 102. The data server 104 can be implemented on a known or convenient computer system. Only one data server 104 is illustrated in FIG. 1, but it should be understood that specific implementations could have multiple servers. Moreover, partial functionality might be provided by a first device and partial functionality might be provided by a second device, where together the first and second devices provide the full functionality attributed to the data server 104.

The datastore 106 and other datastores described in this paper, can be implemented, for example, as software embodied in a physical computer-readable medium on a general- or specific-purpose machine, in firmware, in hardware, in a combination thereof, or in an applicable known or convenient device or system. Datastores described in this paper are intended, if applicable, to include any organization of data, including tables, comma-separated values (CSV) files, traditional databases (e.g., SQL), or other known or convenient organizational formats.

In an example of a system where the datastore 106 is implemented as a database, a database management system (DBMS) can be used to manage the datastore 106. In such a case, the DBMS may be thought of as part of the datastore 106 or as part of the data server 104, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the datastores described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. An optimal structure may vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases, and can include report writers and security mechanisms to prevent unauthorized access. A database transaction mechanism ideally ensures data integrity, even during concurrent user accesses, with fault tolerance. DBMSs can also include a metadata repository; metadata is data that describes other data.

In the example of FIG. 1, the data consumers 108 are coupled to the computer-readable medium 102. The data consumers 108 can be implemented as clients of the data server 104. Regardless of how the relationship with the data server 104 is characterized, the data consumers 108 receive data from the datastore 106, which can include executable software, served by the data server 104.

Multiple data consumers 108 can introduce issues when they are capable of multi-user access to datastores because latency virtualization can result in serving improper data to a second data consumer 108-2 after a first data consumer 108-1 has modified the data. Advantageously, the data accelerator 110 knows what queries have been made and by whom. So if the first data consumer 108-1 modifies a first portion of the datastore 106, the data accelerator 110 can send a downstream notification to the second data consumer 108-2 if the second data consumer 108-2 is known (to the data accelerator 110) to have data associated with the first portion of the datastore 106 in cache. In a specific implementation, a sequence number of notification is maintained in the AIT 112 and the data accelerator 110 does not serve data if the sequence number is not proper. Optionally, if not notification is received for a period of time, a request for the notification can be sent. In a specific implementation, high priority notifications can be sent with a response to prevent the notification from being lost (e.g., put something in a pending state).

In the example of FIG. 1, the data accelerator 110 is coupled to the computer-readable medium 102. The data accelerator 110 is, at least logically, located between the datastore 106 and the data consumers 108. In a specific implementation, the data accelerator 110 has a client component and a server component. The client component can be located at one or more of the data consumers 108, which includes a client application that treats the data accelerator 110 as if it were the data server 104. By “located at one or more of the data consumers 108,” what is meant is the data accelerator 110 can be on a same relatively local network as one or more of the data consumers 108, or on same devices as the one or more data consumers 108. A network is “relatively local” if the network is smaller than a network coupling the data server 104 to a relevant one of the data consumers 108. For example, if the data server 104 is coupled to a relevant one of the data consumers 108 through a wide area network (WAN), then a relatively local network could include a personal area network (PAN), local area network (LAN), a campus area network (CAN), a municipal area network (MAN), or some other network smaller than a WAN. The server component can be located at the data server 104, which treats the data accelerator 110 as if it were the client application. By “located at the data server 104,” what is meant is the data accelerator 110 can be on a same relatively local network as the data server 104, or on same device as the data server 104.

In a specific implementation, the data accelerator 110 is located at a subset of the data consumers 108. In such an implementation, a client application at data consumers of the subset treats the data accelerator 110 as if it were the datastore from which data is being consumed. Thus, the data accelerator 110 can act as a proxy for the datastore 106 (though not necessarily in the technical sense). Generally, the data accelerator 110 will try to serve from cache if possible, but can wait for one of the data consumers 108 to, for example, request a first time, prefetch initially, prefetch based on a recent query, or recache expired data if commonly known.

In another specific implementation, the data accelerator 110 is located at the data server 104. In such an implementation, the data server 104 treats the data accelerator 110 as if it were the client application receiving data from the datastore 106. Thus, the data accelerator 110 can act as a proxy for a data consumer (though not necessarily in the technical sense).

The data accelerator 110 and various devices described in this paper can be implemented with engines. Engines, as described below and in this paper generally, refer to computer-readable media coupled to a processor. The computer-readable media have data, including executable files, that the processor can use to transform the data and create new data. An engine can include a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

In the example of FIG. 1, the AIT 112 is coupled to the data accelerator 110. The AIT 112 is a datastore that stores effects of queries that have been worked out by the data accelerator 110. For example, if a query will change data in the datastore 106, the AIT 112 can include an indication that some cached data needs to be expired. The AIT 112 can facilitate latency virtualization when, for example, executing applications that assume no latency. The AIT 112 can also include operational parameters, such as instructions to never compress/use certain compression, never cache, recache if expired, force prefetch, or cache based on last cache (e.g., prior state on shutdown), to name several.

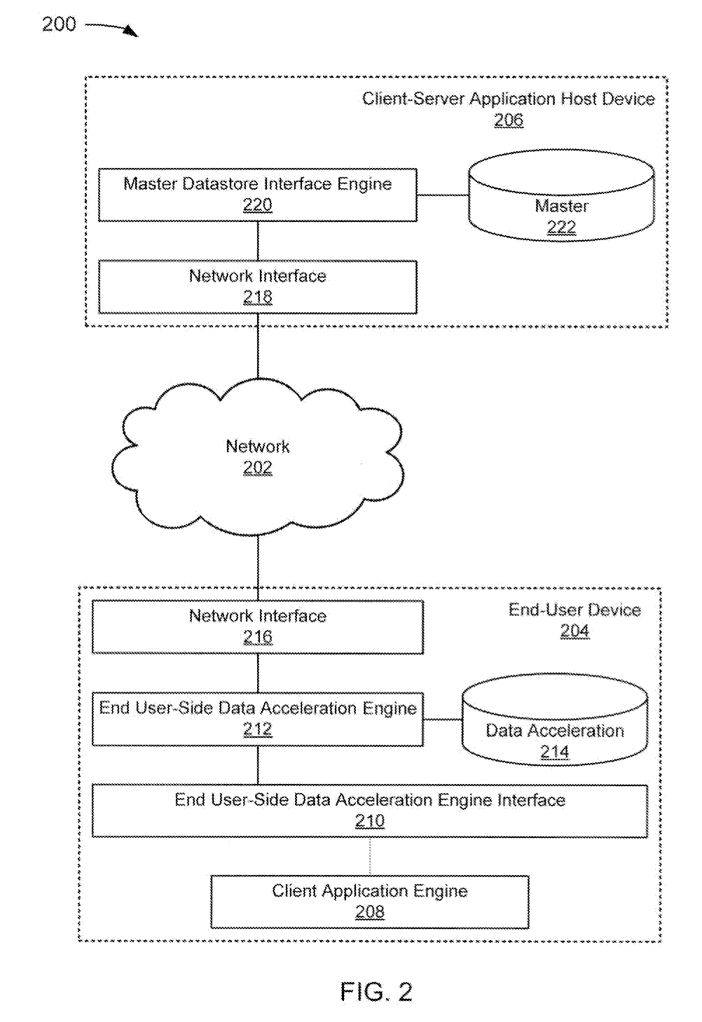

FIG. 2 depicts a diagram 200 of an example of a system with a client-side data accelerator. In the example of FIG. 2, the diagram 200 includes a network 202, an end user (EU) device 204, and a client-server application host device 206. The network 202 can be implemented as described with reference to FIG. 1.

The EU device 204 includes a client application engine 208, an EU-side data acceleration engine interface 210, an EU-side data acceleration engine 212, a data acceleration datastore 214, and a network interface 216. The client application engine 208, in operation, executes at least a portion of an application (“the client application”) on the EU device 204.

For illustrative purposes, the client application needs data during its execution, which the client application engine 208 is configured to request from the client-server application host device 206. Rather than sending the request immediately over the network interface 216, the data request is first sent via the EU-side data acceleration engine interface 210 to the EU-side data acceleration engine 212. Conceptually, the client application engine 208 acts as if the EU-side data acceleration engine interface 210 is the network interface 216. Thus, the client application engine 208 can run a client application without a traditional client-server relationship with an application server.

The data acceleration datastore 214 may or may not include the requested data. The EU-side data acceleration engine 212 can respond to the data request using data in the data acceleration datastore 214 if the data acceleration datastore 214 includes the requested data. The EU-side data acceleration engine 212 can forward the request over the network interface 216 to the client-server application host device 206, or to an intermediary device (not shown) capable of responding to such requests, if the data acceleration datastore 214 does not include the requested data.

The client-server application host device 206 includes a network interface 218, a master datastore interface engine 220, and a master datastore 222. The client-server application host device 206 receives data requests from the EU device 204 over the network interface 218. In a specific implementation, receipt of a data request is an indication that the data acceleration datastore 214 did not include the requested data. For illustrative purposes, the master datastore 222 is expected to include any data the client application engine 208 requests, though it should be understood that the master datastore 222 could be distributed across multiple machines (e.g., on an intermediary device that includes non-redundant data or as part of a distributed system, to name two examples) or the client application engine 208 might be capable of requesting data that is not available. In response to a data request, the master datastore interface engine 220 provides the requested data from the master datastore 222 over the network interface 218.

The EU device 204 receives the requested data on the network interface 216, which can be implemented as an applicable convenient device for coupling the EU device 204 to the network 202. Depending upon configuration- and implementation-specific factors, the EU-side data acceleration engine 212 may or may not store the requested data in the data acceleration datastore 214 to satisfy future requests for the same data locally, though it is believed to be advantageous to store at least some such data locally to satisfy future requests. In any case, the EU-side data acceleration engine 212 provides the requested data to the client application engine 208 to satisfy the client application engine 208's request.

Data from the master datastore 222 can be downloaded to the data acceleration datastore 214 prior to a request for the data being generated. If lucky or if the download is suitably predictive of future data requests, requested data can be in the data acceleration datastore 214 when the data is requested. This can eliminate the latency associated with requesting data over the network 202. Depending upon the resources of the EU device 204, the data acceleration datastore 214 may be incapable of storing all data of the master datastore 222, and an applicable convenient caching algorithm can be used to free up storage. To the extent future requests can be predicted, it would be most desirable to leave data that will be the subject of future requests in the data acceleration datastore 214 when freeing up resources, though predictive caching is not required.

In a specific implementation, the client application engine 208 is coupled to the EU-side data acceleration engine 212 via a TCP connection. Because the client application engine 208 can act as if the data acceleration datastore 214 is actually a server-side datastore (with latency associated with the network 202 eliminated when the data is locally available), it can be useful to employ a known client-to-server connection technique for connecting the client application engine 208 to the EU-side data acceleration engine 212. In such an implementation, the EU-side data acceleration interface 210 can be referred to as a TCP-compatible interface. As used in this paper, “compatible interface” is intended to mean an interface capable of operating within at least one parameter defined by a relevant protocol. More generally, the EU-side data acceleration interface 210 can be referred to as a client-to-server protocol-compatible interface.

Advantageously, despite the apparent client-to-server relationship between the client application engine 208 and the EU-side data acceleration engine 212, the system illustrated by way of example in FIG. 2 enables client-server applications to be hosted (e.g., in the cloud) without server-based computing. It should be understood that the term “server” can generally be applied to any device (even a cloud-based device) that serves content to another device. In this broadest sense, the client-server application host device 206 can be referred to as a server. However, it is theoretically possible in some implementations for the client-server application host device 206 to receive no requests from the EU device 204 where data is provided to the EU-side data acceleration engine 212 prior to any such request, thereby eliminating at least an aspect of server-based computing.

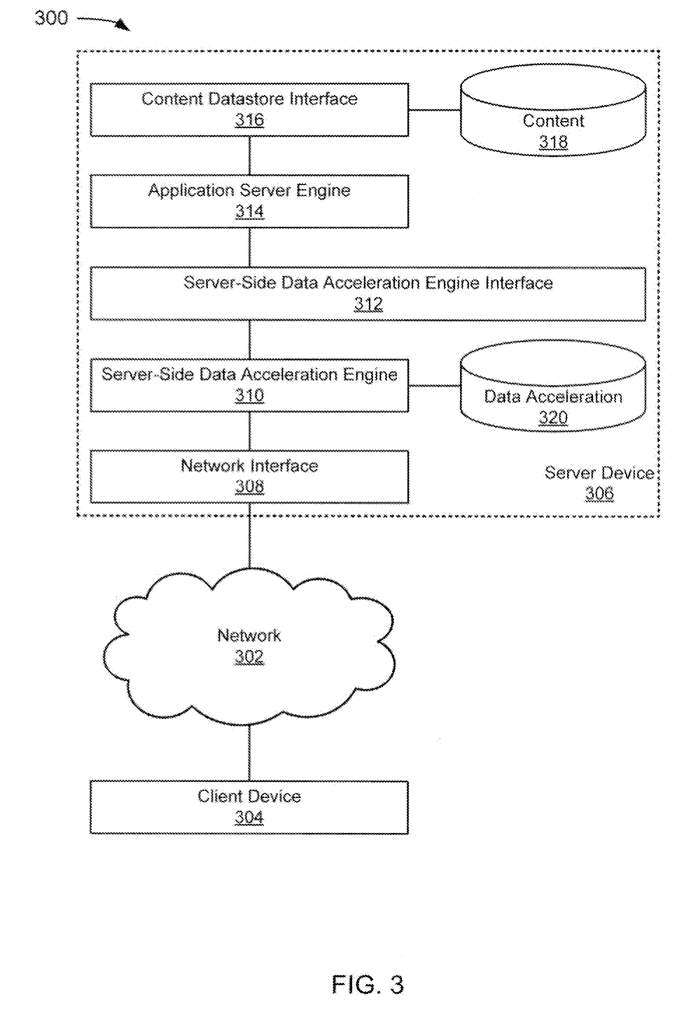

FIG. 3 depicts a diagram 300 of an example of a system with a server-side data accelerator. In the example of FIG. 3, the diagram 300 includes a network 302, a client device 304, and a server device 306. The network 302 can include any applicable devices capable of coupling the client device 304 to the server device 306.

In the example of FIG. 3, the client device 304 is depicted as the client-side of a client-server relationship between the client device 304 and the server device 306. The client device 304 can include an applicable device capable of running an application served at least in part by the server device 306. The client device 304 may or may not include a data acceleration engine.

The server device 306 includes a network interface 308, a server-side data acceleration engine 310, a server-side data acceleration engine interface 312, an application server engine 314, a content datastore interface 316, a content datastore 318, and an acceleration datastore 320. The network interface 308 can be implemented as an applicable convenient device for coupling the server device 306 to the network 302.

In a specific implementation, the application server engine 310 is coupled to the server-side data acceleration engine 310 through the server-side data acceleration engine interface 312. In a specific implementation, the server-side data acceleration engine interface 312 includes a TCP connection. Because the application server engine 314 can act as if the server-side data acceleration engine 310 is actually a client application (with the latency associated with an intervening network eliminated), it can be useful to employ a known server-to-client connection technique for connecting the application server engine 314 to the server-side data acceleration engine 310. In such an implementation, the server-side data acceleration engine interface 312 can be referred to as a TCP-compatible interface. More generally, the server-side data acceleration interface 312 can be referred to as a server-to-client protocol-compatible interface.

In the example of FIG. 3, the application server engine 314 is capable of serving application data from the content datastore 318 to the server-side data acceleration engine 310 of the same type that an application server would normally serve to a client. Depending upon implementation-specific factors, the content datastore 318 can be accessed through the content datastore interface 316, though the content datastore interface 316 can be thought of as a logical interface that may or may not have actual database interface features, drivers, or the like.

In the example of FIG. 3, the server-side data acceleration engine 310 stores data from the content datastore 318, and/or a derivative thereof, in the data acceleration datastore 320. The server-side data acceleration engine 310 can also analyze queries before passing a query onto the application server engine 314 to work out the target and action of a query. Data associated with the analysis of queries can also be stored in the data acceleration datastore 320. Depending upon the query, it may be necessary to resolve the query by sending the query to a master datastore that responds appropriately to the query. This may be required in the case where the query has a locally unidentifiable target or action, for example.

Queries generally include a first portion that identifies a target of the query and a second portion that identifies an action associated with the query. The second portion can include a target category and specific (variable) identifier. An example of a query might include an action, select, a target, table, and an identifier, table_id (which could be an array of tables). After working out a query, it becomes possible to generate a unique key or query template for a set of queries that affects multiple targets. A query template generally strips out variables, such as specific table_id's. A query can be its own key. When a query has been worked out, it becomes possible to determine what affect a query will have on other queries. This knowledge can be used to determine what locally stored data (e.g., cache data) might be out of date.

An out of date (or expired) designation is one possible cache state for data (“expired state”). Expired state can be explicitly set using knowledge to determine whether a query has expired data that is locally stored. Expired state can also be set based upon a time-out. Another possible state is servable state, which is state of locally stored data that is presumed valid. Another possible state is pending state; when the relevant data is determined to be servable, serve and set state to servable and otherwise set state to expired. State can be on a table or page basis, file or block basis, or some other applicable basis.

Working out a query enables one to determine what, e.g., table will be impacted. With such knowledge, all queries for the table could be expired to avoid serving stale local data. With such knowledge, it is possible to determine whether a page is up-to-date, which can make it desirable to set to pending state until what, e.g., table is effected is known. In a specific implementation slow, secure queries, tables, etc. have no chance of serving stale local data, but in an alternative implementation some of the reliability is traded off in favor of speed. In a specific implementation, a user is notified when data might be stale.

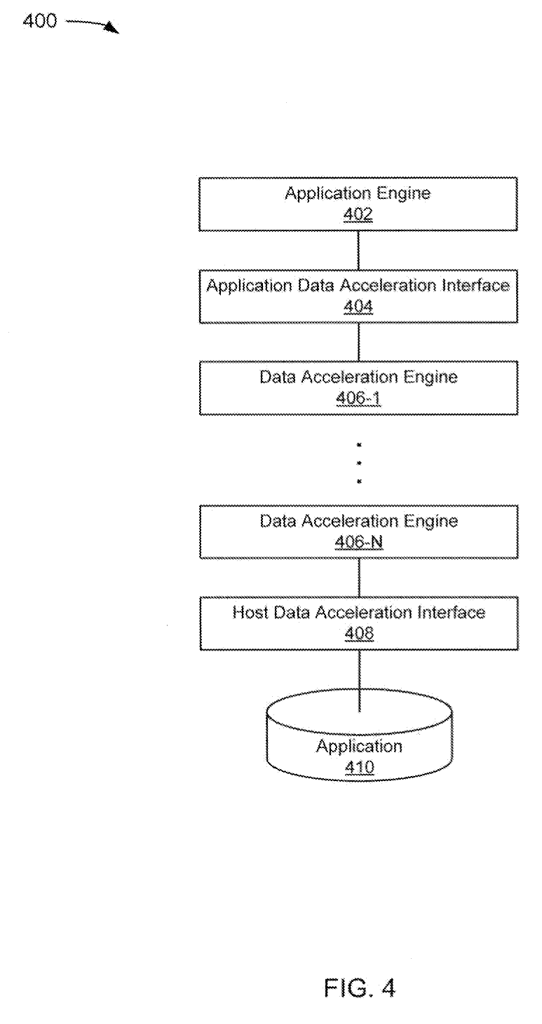

FIG. 4 depicts a diagram 400 of an example of a system with a series of data accelerators. In the example of FIG. 4, the diagram 400 includes an application engine 402, an application data acceleration engine interface 404, a series of data acceleration engines 406, a host data acceleration engine interface 408, and an application datastore 410.

In the example of FIG. 4, the application engine 402 runs a hosted client application. The hosted client application may or may not be hosted by a server in a client-server relationship with a device on which the application engine 402 is associated.

In the example of FIG. 4, the application data acceleration engine interface 404 can couple the application engine 402 to a local data acceleration engine in the manner illustrated by way of example in FIG. 2 (with or without a data acceleration engine that is local relative to the application datastore 410). Alternatively, the application data acceleration engine interface 404 can couple the application engine 402 to a data accelerator that is some degree of remote from the application engine 402 (e.g., on a same LAN, on a same CAN, on a same WAN, or the like), in which case the application data acceleration engine interface 404 can be implemented substantially as a network or other applicable convenient interface.

In the example of FIG. 4, the series of data acceleration engines 406 includes a first data acceleration engine 406-1 that is coupled to the application engine 402. As was previously mentioned, the first data acceleration engine 406-1 can be local relative to the application engine 402 or some degree of remote from the application engine 402. The first data acceleration engine 406-1 can also be local or some degree of remote from other ones of the data acceleration engines 406.

In a specific implementation, the data acceleration engines 406 communicate with one another using UDP. This works because the data acceleration engines 406 know order and can control retransmits with low overhead. The cloud cannot “drop” UDP. Also, additional reliability checks can be added. In a specific implementation, a unique UDP packet with a sequence number (of packets) data field and TCP connection ID field is used to facilitate simplified (relative to TCP) requests/responses. The unique UDP packet can be referred to as a “sequenced TCP connection identifying UDP packet.” In a specific implementation, the application data acceleration interface 404 flips a TCP message to a UDP message that includes the payload of the TCP message. The data acceleration engines 406 send the sequenced TCP connection identifying UDP packet from one to the next, and eventually to the host data acceleration interface 408 where the sequenced TCP connection identifying UDP message is flipped back to TCP. The TCP/UDP/TCP conversion can also take place from the host data acceleration interface 408 to the application data acceleration interface 404. Generalizing, the data acceleration engines 406 use an asynchronous protocol (e.g., UDP) over a network for an order-sensitive activity.

In the example of FIG. 4, the host data acceleration engine interface 408 is coupled to a last data acceleration engine 406-N. The host data acceleration engine interface 408 can be local or some degree of remote from the last data acceleration engine 406-N. The last data acceleration engine 406-N can also be local or some degree of remote from other ones of the data acceleration engines 406.

In the example of FIG. 4, the application datastore 410 can be coupled to a local data acceleration engine by the host data acceleration engine interface 408 in the manner illustrated by way of example in FIG. 3 (with or without data acceleration engine that is local relative to the application engine 402). The application datastore 410 includes data appropriate for provisioning to a client running a served application. In the example of FIG. 4, the host data acceleration engine interface 408 can include a datastore interface 410, an interface may not be needed, or a distinct datastore interface can be provided (not shown).

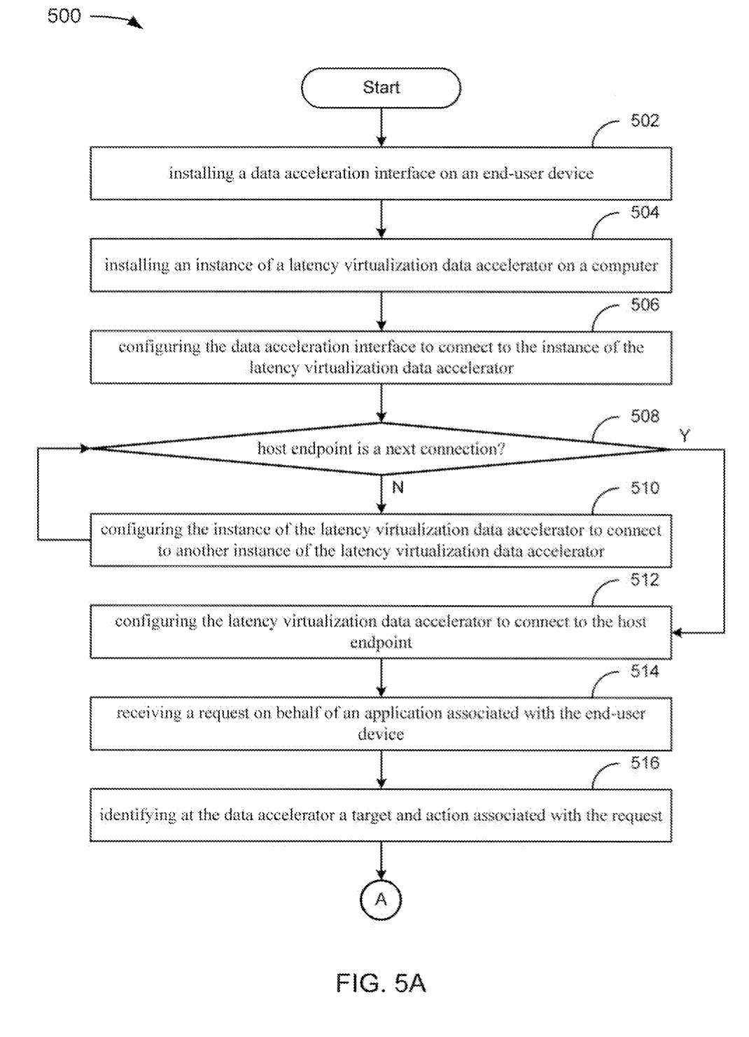

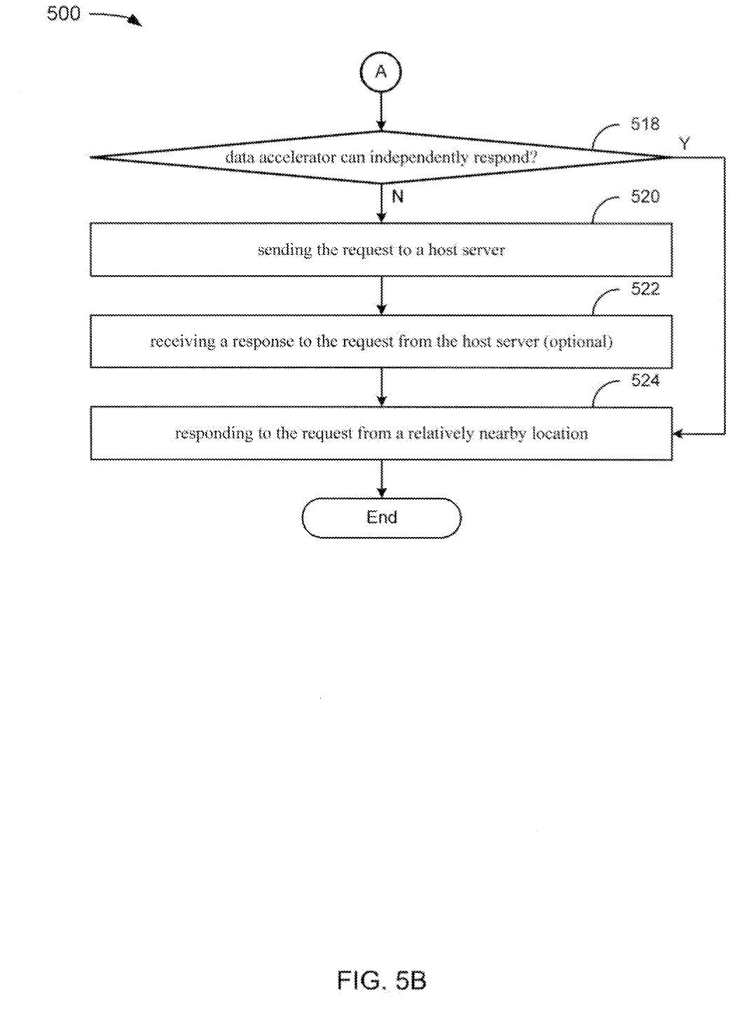

FIGS. 5A and 5B (collectively, FIG. 5), depict a flowchart 500 of an example of a method for latency virtualization. The example of FIG. 5 includes serially-arranged modules, but it should be understood that the modules of the flowchart 500 and other flowcharts described in this paper could be reordered and/or arranged for parallel execution, if applicable.

In the example of FIG. 5, the flowchart 500 starts at module 502 with installing a data acceleration interface on an end-user device. The installation can be part of a manufacturing process, included as part of another software installation, accomplished by downloading and installing an “app” on a device, or in some other applicable manner.

In the example of FIG. 5, the flowchart 500 continues to module 504 with installing an instance of a latency virtualization data accelerator on a computer. As used in this paper, latency virtualization refers to modifying execution parameters of client applications such that any implied reliance upon a minimum latency threshold is addressed in the context of data acceleration. For example, if a client application is configured to send a request to a server and await the response from the server, the client application may assume that a response will not be received before a next instruction is executed. This is because sending and receiving a request over a network normally requires substantially more time than moving to an immediate next instruction of a program.

The instance of the latency virtualization data accelerator installed on the computer can be referred to as a data acceleration engine because the software instance is implemented in hardware (of the computer) and will result in accelerated data provisioning in at least some circumstances. A data accelerator can include a “client-side” latency virtualization instance that is on an EU device with which a relevant application is associated; a “server-side” latency virtualization instance that is on a host device that includes a datastore with data for provisioning to application clients; or a series of latency virtualization instances implemented on devices extending across a link between the EU device and host device (including a series of two, where one is on the end user device and one is on the host device).

In the example of FIG. 5, the flowchart 500 continues to module 506 with configuring the data acceleration interface to connect to the instance of the latency virtualization data accelerator. Depending upon implementation- and/or configuration-specific factors, the data acceleration interface may or may not be configured to connect to a predetermined instance. If so, the module 504 may be reordered to occur before the module 502. (As was previously mentioned, if applicable, a module can be reordered and/or arranged for parallel execution.)

In the example of FIG. 5, the flowchart 500 continues to decision point 508 with determining whether a host endpoint is a next connection for the instance of the latency virtualization data accelerator. If it is determined that a host endpoint is not a next connection (508-N), then the flowchart 500 continues to module 510 with configuring the instance of the latency virtualization data accelerator to connect to another instance of the latency virtualization data accelerator and returns to decision point 508. In this way, a series of data accelerator instances of the data accelerator can be chained together. Each instance of the chain will be installed at some point (see, e.g., module 504), and can accordingly be preinstalled relative to reaching decision point 508, or installed on the fly for a subset of the iterations of the module 510.

If, on the other hand, it is determined that the host endpoint is a next connection (508-Y), then the flowchart 500 continues to module 512 with configuring the data accelerator to connect to the host endpoint. If there were no iterations of module 510, then module 512 entails configuring the instance of the latency virtualization data accelerator to the host endpoint. If there were any iterations of module 510, then module 512 entails configuring a last instance of the data accelerator chain to connect to the host endpoint. It may be noted that there is no particular reason that an instance closer to the data server endpoint be configured after an instance that is farther away; so the last configuration in time may be different from the configuration of the last instance of the data accelerator chain.

In the example of FIG. 5, the flowchart 500 continues to module 514 with receiving a request on behalf of an application associated with the end-user device. Depending upon implementation- and/or configuration-specific factors, the application on the end-user device can have been initiated before or after the start of the flowchart 500. In a specific implementation, the data accelerator can “take over” while the application is running by interjecting the instance of the latency virtualization data accelerator between the application and a datastore of a data server.

In the example of FIG. 5, the flowchart 500 continues to module 516 with identifying at the data accelerator a target and action associated with the request. By working out the target and action, the data accelerator can in some instances respond to the request using a relatively local datastore. In some cases, it may be necessary for the data accelerator to forward the request to a data server and waiting for the response before details of the request can be worked out. In a specific implementation, the data accelerator can save a query or information associated with the request for future reference. In a specific implementation, the data accelerator can share a query or information associated with the request with other data accelerators. In a specific implementation, the data accelerator can consolidate multiple queries into a single query.

In the example of FIG. 5, the flowchart 500 continues to decision point 518 where it is determined whether the data accelerator can independently respond to the request. If it is determined that the data accelerator cannot independently respond to the request (518-N), then the flowchart 500 continues to module 520 with sending the request to a host server and to module 522 with receiving a response to the request from the host server. If the request includes a write instruction, the host server may or may not send a response to the request. For some known databases, write confirmations are used, but that is not a requirement. Thus, the module 522 is optional in at least some cases. If, on the other hand, it is determined that the data accelerator can independently respond to the request (518-Y), then the flowchart 500 skips the modules 520 and 522.

In the example of FIG. 5, the flowchart 500 continues to module 524 with responding to the request from a relatively nearby location. As used in this paper, a relatively nearby location in this context is a location that is closer than the host server. In a specific implementation, if latency is lower from a first location than a second location, then the first location is relatively nearer than the second location. It may be desirable to send information to the host server even if the data accelerator can independently respond to the request. Advantageously, such reporting can be handled over a channel that is different from the one used by the application on the end-user device such that latency associated with requests from the application is not increased thereby. In an implementation in which a data accelerator is located entirely at the host server, the text of module 524 can be replaced with “responding to the request by the data accelerator.”

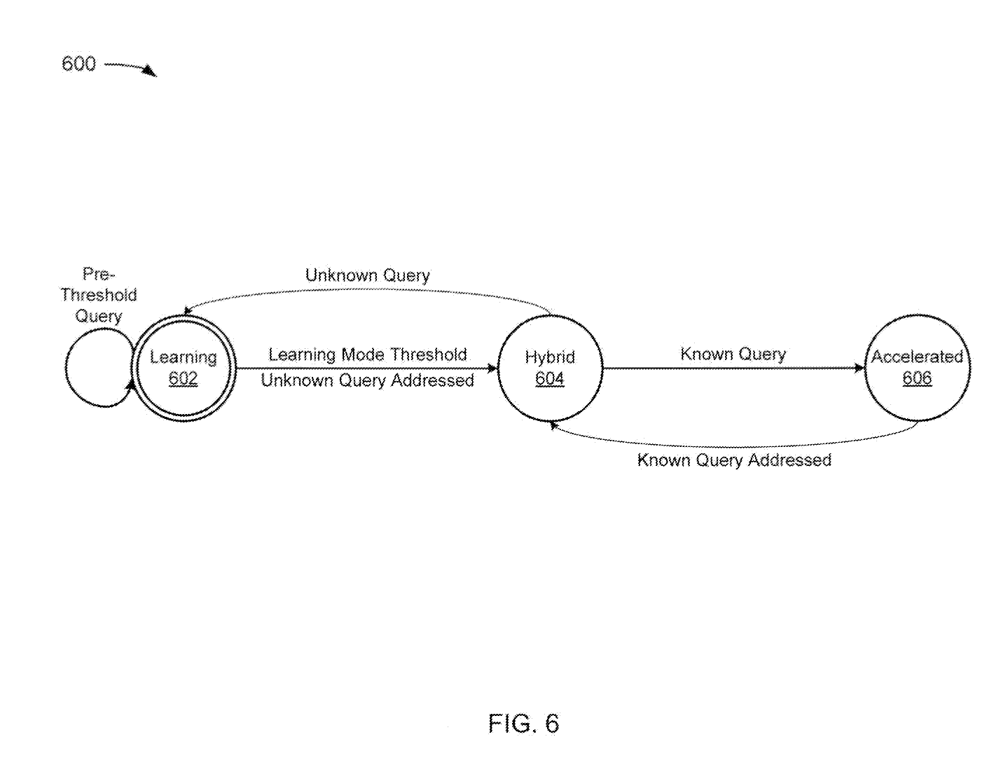

FIG. 6 depicts a state diagram 600 of an example of states of an application with virtualized latency. In the example of FIG. 6, a learning state 602 is a starting state of the state diagram 600. In learning mode, a latency virtualizing data accelerator analyzes queries from an application to work out a target and action associated with the queries. Data received from a master server in response to the queries can be cached locally. After a learning mode threshold is passed, state transitions to a hybrid state 604. The learning mode threshold can be based upon time, number of queries, size of cache, cache utilization, or some other applicable metric. In hybrid mode, if an unknown query is received, state transitions to the learning state 602 (and state transitions back to the hybrid state 604 after the query is addressed); if a known query is received, state transitions to an accelerated state 606. Addressing a query entails responding to the query (from a local datastore if the query is known) and, if the query is unknown, working out a target and action of the query. In accelerated mode, a latency virtualizing data accelerator can satisfy a known query from a local cache that includes data obtained during the learning state 602. After satisfying a known query, state transitions from the accelerated state 606 back to the hybrid state 604. In an alternative to the example of FIG. 6, the starting state could be the hybrid state 604. In this alternative, there would be no initial learning mode threshold.

The detailed description discloses examples and techniques, but it will be appreciated by those skilled in the relevant art that modifications, permutations, and equivalents thereof are within the scope of the teachings. It is therefore intended that the following appended claims include all such modifications, permutations, and equivalents. While certain aspects of the invention are presented below in certain claim forms, the applicant contemplates the various aspects of the invention in any number of claim forms. For example, while only one aspect of the invention is recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to add additional claims after filing the application to pursue such additional claim forms for other aspects of the invention.

What is claimed is:

1. A method comprising:
installing a data acceleration interface on an end-user device;
installing an instance of a latency virtualization data accelerator on a computer;
configuring the data accelerator interface to connect to the instance of the latency virtualization data accelerator;
configuring the latency virtualization data accelerator to connect to a host endpoint;
receiving a request on behalf of an application associated with the end-user device;
identifying at the data accelerator a target and action associated with the request;
responding to the request from a relatively nearby location.

2. The method of claim 1, further comprising configuring the instance of the latency virtualization data accelerator to connect to second one or more instances of the latency virtualization data accelerator until the host endpoint is a next connection of a last of the second one or more instances.

3. The method of claim 1, further comprising sending the request to a host server when the data accelerator cannot independently respond.

4. The method of claim 3, further comprising receiving a response to the request from the host server.

5. A system comprising:
a means for installing a data acceleration interface on an end-user device;
a means for installing an instance of a latency virtualization data accelerator on a computer;
a means for configuring the data accelerator interface to connect to the instance of the latency virtualization data accelerator;
a means for configuring the latency virtualization data accelerator to connect to a host endpoint;
a means for receiving a request on behalf of an application associated with the end-user device;
a means for identifying at the data accelerator a target and action associated with the request;
a means for responding to the request from a relatively nearby location.

6. The system of claim 5, further comprising a means for configuring the instance of the latency virtualization data accelerator to connect to second one or more instances of the latency virtualization data accelerator until the host endpoint is a next connection of a last of the second one or more instances.

7. The system of claim 5, further comprising a means for sending the request to a host server when the data accelerator cannot independently respond.

8. The system of claim 7, further comprising a means for receiving a response to the request from the host server.

9. A method comprising:
installing a data acceleration interface on an end-user device;
configuring the data accelerator interface to connect to an instance of a latency virtualization data accelerator;
sending a request on behalf of an application associated with the end-user device;
receiving a response to the request from a relatively nearby location.

10. The method of claim 9, further comprising installing an instance of a latency virtualization data accelerator on a computer.

11. The method of claim 9, further comprising configuring the instance of the latency virtualization data accelerator to connect to another instance of the latency virtualization data accelerator until a host endpoint is a next connection.

12. The method of claim 9, further comprising configuring the latency virtualization data accelerator to connect to a host endpoint.

13. The method of claim 9, further comprising receiving a request on behalf of an application associated with the end-user device.

14. The method of claim 9, further comprising identifying at the data accelerator a target and action associated with the request.

15. The method of claim 9, further comprising sending the request to a host server when the data accelerator cannot independently respond.

16. The method of claim 9, further comprising responding to the request from a relatively nearby location.
